(19) United States
(12) Patent Application Publication
(10) Pub. No.: US 2009/0200992 A1
(43) Pub. Date: Aug. 13, 2009

(54) U-POWER Portable Entertainment Center and Power Supply

(76) Inventor: Tim Gilbert Stewart, Spring Hill, FL (US)

Correspondence Address: Solar Star Inc DBA Stewart Mechanical, 1228 S. Jamestown, Tulsa, OK, 74112, US

(21) Appl. No.: 12/028,823

(22) Filed: Feb. 10, 2008

(51) Int. Cl. H02K 7/18; H02K 7/116

(52) U.S. Cl. 322/1

(57) ABSTRACT

A self contained unit to provide portable electrical power consisting of a generator, storage battery, power inverter, and AC/DC power outlets. The case provides mounting for various electrical and electronic entertainment equipment including but not limited to a LCD video monitor, CD/VCR player, MP3 docking station, and audio speakers. Power is generated by pushing, pulling, or turning the generator by provided pedals.

The U-POWER unit consists of an internal frame for mounting of the generator, wheel shafts, drive shafts and gears, battery mounting, and a molded plastic outer case for component mounting. By pushing or pulling the unit, one set of drive gears turn the generator to recharge the storage battery. The generator can also be turned in a stationary position through a second set of drive gears attached the pedal shaft. Power provided by the storage battery is used for the electronic components and inverted for AC power. The unit can also be equipped with an AC battery charger to be used when external electrical power is available.

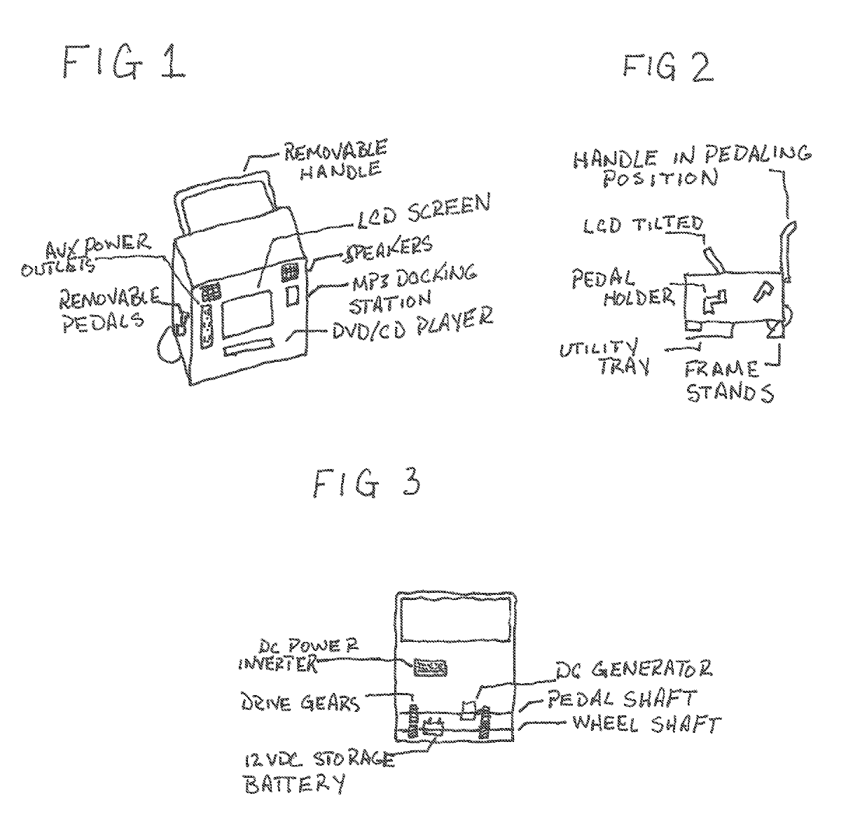

1. FIG. 1 Shows the front, top, and partial side view of the unit in the upright position. This view also identifies the general location of the external components.

2. FIG. 2 Shows the right side view of the unit in the horizontal position with the foot pedals and handle repositioned for recharging of the battery via the foot pedals.

3. FIG. 3 Shows the back internal view identifying the general configuration and component locations of the electrical power system.

1. The U-POWER unit provides a source of portable AC/DC power and an indoor or outdoor entertainment system requiring no external power for operation. The unit is ideally suited for areas where grid power is not available and the use of engine driven portable generators may not be desirable or practical such as camping areas, parks and recreation areas.
